(19) United States
(12) Patent Application Publication
(10) Pub. No.: US 2005/0140581 A1
(43) Pub. Date: Jun. 30, 2005

(54) Method of driving plasma display panel (PDP)

(76) Inventors: Kyoung-Doo Kang, Seoul (KR); Hun-Suk Yoo, Cheonan-si (KR); Won-Ju Yi, Suwon-si (KR)

Correspondence Address: Robert E. Bushnell, Suite 300, 1522 K. Street, Washington, DC, 20005-1202, US

(21) Appl. No.: 10/995,538

(22) Filed: Nov. 24, 2004

(30) Foreign Application Priority Data
Nov. 29, 2003 (KR) 2003-86064

(51) Int. Cl. G09G 3/28

(52) U.S. Cl. 345/60

(57) ABSTRACT

A method of driving a plasma display panel in which a plurality of sub-fields for time division gray-scale display exist in each frame which is a display period, and each of the sub-fields includes a reset period, an address period and a discharge-sustaining period. In the discharge-sustaining period, a sustaining pulse of a second level voltage based on a first level voltage is supplied to each Y-electrode line and X-electrode line according to a Y-supplied electrical-potential period and an X-supplied electrical-potential period. Each Y-supplied and X-supplied electrical-potential period includes a rising time to rise from the first level voltage to the second level voltage, a sustaining time to sustain the second level voltage, and a falling time to fall from the second level voltage to the first level voltage. An intermittent time to sustain the first level voltage, an intermittent time of the Y-supplied electrical-potential period, and an intermittent time of the X-supplied electrical-potential period do not overlap each other.

### CLAIM OF PRIORITY

This application makes reference to, incorporates the same herein, and claims all benefits accruing under 35 U.S.C. §119 from an application for DRIVING METHOD OF PLASMA DISPLAY PANEL earlier filed in the Korean Intellectual Property Office on 29 Nov. 2003 and there duly assigned Serial No. 2003-86064.

### BACKGROUND OF THE INVENTION

1. Field of the Invention

The present invention relates to a method of driving a Plasma Display Panel (PDP), and more particularly, to a method of driving a PDP with a high frequency overlapped-time sustaining arrangement by which sustaining pulses supplied to each X-electrode and Y-electrode overlap one another during a discharge-sustaining period and an overlapped time period is adjusted such that an emission efficiency is increased and a discharge-sustaining time period is reduced.

2. Description of the Related Art

In a three-electrode, surface-discharge PDP, address electrode lines A_{R1}, A_{G1}, . . . A_{Gm}, and A_{Bm}, dielectric layers, Y-electrode lines Y₁, . . . , and Yₙ, X-electrode lines X₁, . . . , and Xₙ, a phosphor layer, partition walls, and an MgO layer used as a protective layer are disposed between front and rear glass substrates of the surface-discharge PDP.

The address electrode lines A_{R1}, A_{G1}, . . . , A_{Gm}, and A_{Bm} are formed in a predetermined pattern on a front side of the rear glass substrate. The entire surface of the lower dielectric layer is coated on the front of the address electrode lines A_{R1}, A_{G1}, . . . , A_{Gm}, and A_{Bm}. The partition walls are formed on a front side of the lower dielectric layer to be parallel to the address electrode lines A_{R1}, A_{G1}, . . . , A_{Gm}, and A_{Bm}. The partition walls partition off a discharge area of each display cell and prevent optical cross-talk between the display cells. The phosphor layer is formed between the partition walls.

The X-electrode lines X₁, . . . , and Xₙ and the Y-electrode lines Y₁, . . . , and Yₙ are formed in a predetermined pattern on a rear side of the front glass substrate so as to be orthogonal to the address electrode lines A_{R1}, A_{G1}, . . . , A_{Gm}, and A_{Bm}. A corresponding display cell is formed at cross points of the X-electrode lines X₁, . . . , and Xₙ and the Y-electrode lines Y₁, . . . , and Yₙ. Each of the X-electrode lines X₁, . . . , and Xₙ and each of the Y-electrode lines Y₁, . . . , and Yₙ are formed such that transparent electrode lines formed of a transparent conductive material, such as Indium Tin Oxide (ITO) or metallic electrode lines used to improve conductivity, are combined with one another. The front dielectric layer is formed such that the entire surface of the front dielectric layer is coated on rear sides of the X-electrode lines X₁, . . . , and Xₙ and the Y-electrode lines Y₁, . . . , and Yₙ. The protective layer for protecting the PDP 1 from a strong electric field, for example, an MgO layer, is formed such that the entire surface of the MgO layer is coated on a rear side of the upper dielectric layer. A gas used in a forming plasma is sealed in a discharge space.

An Address-Display Separation (ADS) method of driving the PDP 1 with the above-described structure that is commonly used is disclosed in U.S. Pat. No. 5,541,618.

The apparatus for driving the PDP includes an image processor, a logic controller, an address driver, an X-driver, and a Y-driver. The image processor converts an external analog image signal into a digital signal and generates internal image signals, for example, 8-bit red (R), green (G), and blue (B) image data, a clock signal, and vertical and horizontal synchronous signals. The logic controller generates driving control signals S_{A}, S_{Y}, and S_{X} in response to the internal image signals generated by the image processor.

The driving control signals S_{A}, S_{Y}, and S_{X} are respectively inputted to the address driver, the X-driver, and the Y-driver so that driving signals are generated and the generated driving signals are supplied to electrode lines.

In other words, the address driver generates display data signals by processing the address signal SA among the driving control signals S_{A}, S_{Y}, and S_{X} generated by the logic controller and supplies the display data signals to address electrode lines. The X-driver processes the X-driving control signal S_{X} among the driving control signals S_{A}, S_{Y}, and S_{X} generated by the logic controller and supplies the X-driving control signal S_{X} to X-electrode lines. The Y-driver processes the Y-driving control signal SY among the driving control signals S_{A}, S_{Y}, and S_{X} generated by the logic controller 22 and supplies the Y-driving control signal S_{Y} to Y-electrode lines.

In a method of driving the PDP, a unit frame is divided into eight sub-fields SF1, . . . , and SF8, in order to realize a time division gray-scale display. In addition, each of the sub-fields SF1, . . . , and SF8 is divided into reset periods R1, . . . , and R8, address periods A1, . . . , and A8, and discharge-sustaining periods S1, . . . , and S8.

The brightness of a PDP is directly proportional to the lengths of the discharge-sustaining periods S1, . . . , and S8 of the unit frame. The lengths of the discharge-sustaining periods S1, . . . , and S8 of the unit frame are 255T (T is a unit time). A time corresponding to 2n is set to a discharge-sustaining period Sn of an n-th sub-field SFn. As such, a sub-field to be displayed is properly selected from the eight sub-fields so that display of 256 level gray-scale including zero gray scale that is not displayed in any sub-field is performed.

In the PDP discussed above, S_{AR1} . . . A_{Bm} are a driving signal supplied to each address electrode line (A_{R1}, A_{G1}, . . . , A_{Gm}, and A_{Bm}), S_{X1} . . . Xₙ denotes a driving signal supplied to X-electrode lines (X₁, . . . , and Xₙ), and reference numeral S_{Y1}, . . . Yₙ denotes a driving signal supplied to each Y-electrode line (Y₁, . . . , and Yₙ).

In a reset period PR of a unit sub-field SF, first, a voltage supplied to the X-electrode lines X₁, . . . , and Xₙ is increased continuously from a ground voltage V_{G} to a second voltage V_{S}, for example, up to 155V. Here, the ground voltage V_{G} is supplied to the Y-electrode lines Y₁, . . . , and Yₙ and the address electrode lines A_{R1}, A_{G1}, . . . , A_{Gm}, and A_{Bm}.

A voltage supplied to the Y-electrode lines Y₁, . . . , and Yₙ is increased continuously from a second voltage V_{S}, for example, 155V, to a maximum voltage V_{SET}+V_{S} higher than the second voltage V_{S} by a third voltage V_{SET}, for example, up to 355 V. The ground voltage V_{G} is supplied to the X-electrode lines X₁, . . . , and Xₙ and the address electrode lines A_{R1}, A_{G1}, . . . , A_{Gm}, and A_{Bm}.

While the voltage supplied to the X-electrode lines X₁, . . . , and Xₙ is maintained at the second voltage V_{S}, the voltage supplied to the Y-electrode lines Y₁, . . . , and Yₙ is decreased continuously from the second voltage Vs to the ground voltage V_{G}. The ground voltage V_{G} is supplied to the address electrode lines A_{R1}, A_{G1}, . . . , A_{Gm}, and A_{Bm}.

As such, in a in a subsequent address period PA, a display data signal is supplied to address electrode lines, and a scan pulse of the ground voltage V_{G} is sequentially supplied to the Y-electrode lines Y₁, . . . , and Yₙ, which is biased to a fourth voltage V_{SCAN} lower than the second voltage V_{S}, such that addressing is smoothly performed. When a discharge cell is to be selected, the display data signal supplied to each of the address electrode lines A_{R1}, A_{G1}, . . . , A_{Gm}, and A_{Bm} has a positive-polarity address voltage V_{A}, and when the discharge cell is not to be selected, the display data signal has the ground voltage V_{G}. As such, when the display data signal having the positive-polarity address voltage V_{A} is supplied to selected address electrode lines, and A_{Bm} while the scan pulse of the ground voltage V_{G} is supplied to the Y-electrode lines Y₁, . . . , and Yₙ, wall charges are formed in corresponding discharge cells by an address discharge, and the wall charges are not formed in non-corresponding discharge cells. In order to perform an address discharge more precisely and effectively, the second voltage V_{S} is supplied to the X-electrode lines X₁, . . . , and Xₙ.

In a subsequent discharge-sustaining period PS, display-sustaining pulses of the second voltage VS are alternately supplied to all of the Y-electrode lines Y₁, . . . , and Yₙ and the X-electrode lines X₁, . . . , and Xₙ such discharge for display-sustaining occurs in display cells in which the wall charges are formed in a corresponding address period PA.

In a discharge-sustaining period, a predetermined number of sustaining pulses of a discharge-sustaining voltage VS are alternately supplied to each of the X-electrode lines X₁, . . . , and Xₙ and the Y-electrode lines Y₁, . . . , and Yₙ based on the reference electrical-potential V_{G} at each sub-field. Each of the sustaining pulses is composed of a rising time Tᵣ, a sustaining time Tₛ, a falling time T_{f}, and an intermittent time T_{g} according to time. The rising time Tᵣ and the falling time T_{f} are respectively rising and falling times taken for charging and recovering an energy, the sustaining-time Tₛ is a time taken for sustaining the discharge-sustaining voltage V_{S}, and the intermittent time T_{g} is a time taken for sustaining the reference electrical-potential V_{G}.

The time of one sustaining pulse is approximately 4-5 μs, and the rising time Tᵣ and the falling time T_{f} are both approximately 0.3-0.5 μs. Sustaining pulses are alternately and continuously supplied to each of the X-electrode lines X₁, . . . , and Xₙ and the Y-electrode lines Y₁, . . . , and Yₙ so that the sustaining pulses do not overlap with one another and the sustaining time Tₛ of an X-supplied electrical-potential period Tₓ and the sustaining time Tₛ of a Y-supplied electrical-potential period T_{y} do not overlap with one another.

Due to the sum of a difference V_{Y-X} in electrical-potential supplied to each of the X-electrode lines X₁, . . . , and Xₙ and the Y-electrode lines Y₁, . . . , and Yₙ and a wall voltage V_{W}, a sustaining discharge occurs in a discharge-sustaining period. In other words, when the sum of the Y-X electrical-potential V_{Y-X} and the wall voltage V_{W} is greater than a discharge start voltage, a discharge begins.

However, when the intermittent time T_{g} of the X-supplied electrical-potential period Tₓ and the intermittent time T_{g} of the Y-supplied electrical-potential period T_{y} do not overlap with one another, the time of the display-sustaining period during which a predetermined number of sustaining pulses are supplied to each of the X-electrode lines X₁, . . . , and Xₙ and the Y-electrode lines Y₁, . . . , and Yₙ is long, which results in the restriction of high-speed driving. In other words, in this method of driving a PDP, when the discharge-sustaining period is 4-5 μs, a discharge-sustaining frequency of 200-250 kHz is obtained. In addition, since an energy recovery circuit is used in increasing the energy efficiency of a driving circuit, a discharge-sustaining period of approximately 0.3-0.5 μs is needed in each of the rising time Tᵣ and the falling time T_{f}. Therefore, it is difficult to perform sustaining driving with a frequency of over 300 kHz.

### SUMMARY OF THE INVENTION

The present invention provides a method of driving a plasma display panel (PDP) with a high frequency overlapped time sustaining arrangement by which sustaining pulses supplied to each X-electrode and Y-electrode overlap one another during a discharge-sustaining period and an overlapped time period is adjusted such that emission efficiency is increased and a discharge-sustaining time period is reduced.

According to one aspect of the present invention, a method of driving a plasma display panel is provided, the method comprising: arranging discharge cells in an area in which address electrode lines overlap with one another with respect to sustaining-electrode line pairs in which X-electrode lines and Y-electrode lines between a pair of opposite substrates are alternately arranged in a direction perpendicular to the substrates; and providing a plurality of sub-fields for time division gray-scale display in each frame of a display period, each of the plurality of sub-fields including a reset period, an address period and a discharge-sustaining period; wherein, in the discharge-sustaining period, a sustaining pulse of a second level voltage based on a first level voltage is respectively supplied to each of the Y-electrode lines and X-electrode lines according to a Y-supplied electrical-potential period and an X-supplied electrical-potential period; wherein each Y-supplied electrical-potential period and X-supplied electrical-potential period includes a rising time to rise from the first level voltage to the second level voltage, a sustaining time to sustain the second level voltage, a falling time to fall from the second level voltage to the first level voltage; and wherein an intermittent time to sustain the first level voltage, and an intermittent time of the Y-supplied electrical-potential period and an intermittent time of the X-supplied electrical-potential period do not overlap each other in time.

The sustaining time is preferably longer than the intermittent time, in both the Y-supplied electrical-potential period and the X-supplied electrical-potential period.

The Y-supplied electrical-potential period and the X-supplied electrical-potential period preferably have the same period.

Each of the rising time, the sustaining time, the falling time, and the intermittent time in the Y-supplied electrical-potential period is preferably supplied during the same time interval as each of the rising time, the sustaining time, the falling time, and the intermittent time in the X-supplied electrical-potential period.

At least one of the rising time of the Y-supplied electrical-potential period and the falling time of the X-supplied electrical-potential period is preferably respectively supplied together with at least one of the falling time of the Y-supplied electrical-potential period and the rising time of the X-supplied electrical-potential period simultaneously.

According to another aspect of the present invention, a method of driving a plasma display panel is provided, the method comprising: arranging discharge cells in an area in which address electrode lines overlap with one another with respect to sustaining-electrode line pairs in which X-electrode lines and Y-electrode lines between a pair of opposite substrates are alternately arranged in a direction perpendicular to the substrates; and providing a plurality of sub-fields for time division gray-scale display in each frame of a display period, each of the plurality of sub-fields including a reset period, an address period and a discharge-sustaining period; wherein, in the discharge-sustaining period, a sustaining pulse of a second level voltage based on a first level voltage is respectively supplied to each of the Y-electrode lines and X-electrode lines according to a Y-supplied electrical-potential period and an X-supplied electrical-potential period; wherein each Y-supplied electrical-potential period and X-supplied electrical-potential period includes a rising time to rise from the first level voltage to the second level voltage, a sustaining time to sustain the second level voltage, a falling time to fall from the second level voltage to the first level voltage; and wherein at least one of portions of the rising time, the falling time, and the sustaining time of each Y-supplied electrical-potential period and X-supplied electrical-potential period overlap each other in time.

A time in which the Y-supplied electrical-potential period and the X-supplied electrical-potential period overlap each other is preferably longer than both the rising time and the falling time.

The sustaining time is preferably longer than the intermittent time in each of the Y-supplied and X-supplied electrical-potential periods.

The Y-supplied electrical-potential period and the X-supplied electrical-potential period preferably have the same period.

According to the present invention, a discharge-sustaining time period is reduced such that a high-frequency sustaining driving can be performed, and a sufficient driving time is used such that an emission efficiency can be increased.

### BRIEF DESCRIPTION OF THE DRAWINGS

The above and other aspects and advantages of the present invention will become more apparent by describing in detail exemplary embodiments thereof with reference to the attached drawings in which:

FIG. 1 is an internal perspective view of a structure of a three-electrode, surface-discharge PDP;

FIG. 2 is a block diagram of an apparatus for driving the PDP of FIG. 1;

FIG. 3 is a timing diagram of a method of driving the PDP of FIG. 1;

FIG. 4 is a timing diagram of driving signals supplied to electrode lines of the PDP of FIG. 1 in a unit sub-field of FIG. 3;

FIG. 5 is a timing diagram of X-supplied electrical-potential, Y-supplied electrical-potential, and a Y-X electrical-potential difference of a discharge-sustaining period of the driving signals of FIG. 4;

FIG. 6 is a perspective view of a ring plasma discharge PDP according to an embodiment of the present invention in which a method of driving a PDP according to the present invention is performed;

FIG. 7 is a timing diagram of a method of driving a PDP according to an embodiment of the present invention;

FIG. 8 is a timing diagram of X-supplied electrical-potential, Y-supplied electrical-potential, and a Y-X electrical-potential difference of a discharge-sustaining period of driving signals of FIG. 7;

FIGS. 9 and 10 are views of methods of driving a plasma display panel according to another embodiments of the present invention, which are timing diagrams illustrating X-supplied electrical-potential, Y-supplied electrical-potential, and a Y-X electrical-potential difference of a discharge-sustaining period of driving signals of FIG. 7;

FIG. 11 is a graph of an emission efficiency with respect to discharge-sustaining pulse frequency in the method of driving a PDP of FIGS. 7 through 10; and

FIG. 12 is a graph of power consumption with respect to discharge-sustaining pulse frequency in the method of driving a PDP of FIGS. 7 through 10.

### DETAILED DESCRIPTION OF THE INVENTION

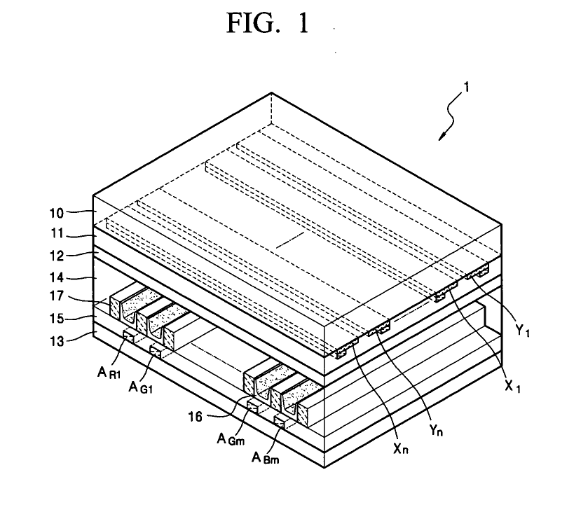

FIG. 1 is an internal perspective view of the structure of a three-electrode, surface-discharge PDP 1. Referring to FIG. 1, address electrode lines A_{R1}, A_{G1}, . . . , A_{Gm} and A_{Bm}, dielectric layers 11 and 15, Y-electrode lines Y₁, . . . , and Yₙ, X-electrode lines X₁, . . . , and Xₙ, a phosphor layer 16, partition walls 17, and an MgO layer 12 used as a protective layer are disposed between front and rear glass substrates 10 and 13 of the surface-discharge PDP 1.

The address electrode lines A_{R1}, A_{G1}, . . . , A_{Gm}, and A_{Bm} are formed in a predetermined pattern on a front side of the rear glass substrate 13. The entire surface of the lower dielectric layer 15 is coated on the front of the address electrode lines A_{R1}, A_{G1}, . . . , A_{Gm}, and A_{Bm}. The partition walls 17 are formed on a front side of the lower dielectric layer 15 to be parallel to the address electrode lines A_{R1}, A_{G1}, . . . , A_{Gm}, and A_{Bm}. The partition walls 17 partition off a discharge area of each display cell and prevent optical cross-talk between the display cells. The phosphor layer 16 is formed between the partition walls 17.

The X-electrode lines X₁, . . . , and Xₙ and the Y-electrode lines Y₁, . . . , and Yₙ are formed in a predetermined pattern on a rear side of the front glass substrate 10 so as to be orthogonal to the address electrode lines A_{R1}, A_{G1}, . . . , A_{Gm}, and A_{Bm}. A corresponding display cell is formed at cross points of the X-electrode lines X₁, . . . , and Xₙ and the Y-electrode lines Y₁, . . . , and Yₙ. Each of the X-electrode lines X₁, . . . , and Xₙ and each of the Y-electrode lines Y₁, . . . , and Yₙ are formed such that transparent electrode lines formed of a transparent conductive material, such as Indium Tin Oxide (ITO) or metallic electrode lines used to improve conductivity, are combined with one another. The front dielectric layer 11 is formed such that the entire surface of the front dielectric layer 11 is coated on rear sides of the X-electrode lines X₁, . . . , and Xₙ and the Y-electrode lines Y₁, . . . , and Yₙ. The protective layer 12 for protecting the PDP 1 from a strong electric field, for example, an MgO layer, is formed such that the entire surface of the MgO layer 12 is coated on a rear side of the upper dielectric layer 11. A gas used in a forming plasma is sealed in a discharge space 14.

An Address-Display Separation (ADS) method of driving the PDP 1 with the above-described structure that is commonly used is disclosed in U.S. Pat. No. 5,541,618.

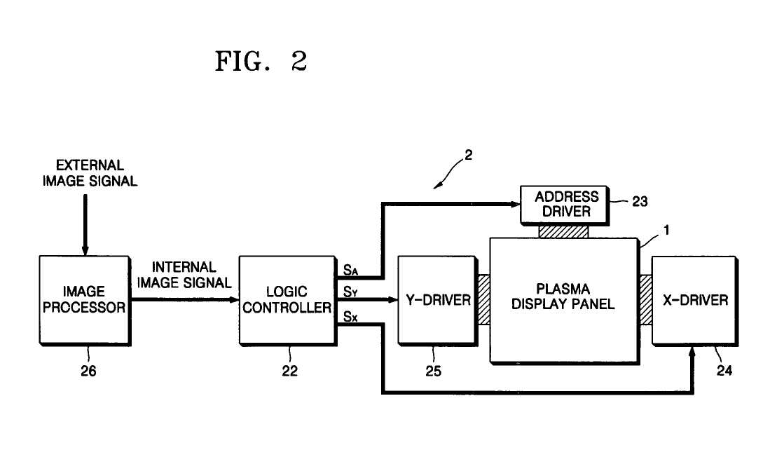

FIG. 2 is a block diagram of an apparatus for driving the PDP 1 of FIG. 1. Referring to FIG. 2, the apparatus 2 for driving the PDP 1 includes an image processor 26, a logic controller 22, an address driver 23, an X-driver 24, and a Y-driver 25. The image processor 26 converts an external analog image signal into a digital signal and generates internal image signals, for example, 8-bit red (R), green (G), and blue (B) image data, a clock signal, and vertical and horizontal synchronous signals. The logic controller 22 generates driving control signals S_{A}, S_{Y}, and S_{X} in response to the internal image signals generated by the image processor 26.

The driving control signals S_{A}, S_{Y}, and S_{X} are respectively inputted to the address driver 23, the X-driver 24, and the Y-driver 25 so that driving signals are generated and the generated driving signals are supplied to electrode lines.

In other words, the address driver 23 generates display data signals by processing the address signal SA among the driving control signals S_{A}, S_{Y}, and S_{X} generated by the logic controller 22 and supplies the display data signals to address electrode lines. The X-driver 24 processes the X-driving control signal S_{X} among the driving control signals S_{A}, S_{Y}, and S_{X} generated by the logic controller 22 and supplies the X-driving control signal S_{X} to X-electrode lines. The Y-driver 25 processes the Y-driving control signal SY among the driving control signals S_{A}, S_{Y}, and S_{X} generated by the logic controller 22 and supplies the Y-driving control signal S_{Y} to Y-electrode lines.

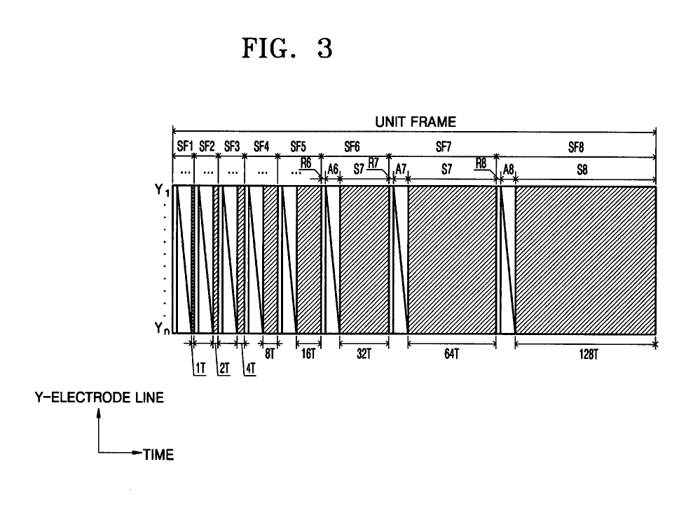

FIG. 3 is a timing diagram of a method of driving the PDP of FIG. 1. Referring to FIG. 3, a unit frame is divided into eight sub-fields SF1, . . . , and SF8, in order to realize a time division gray-scale display. In addition, each of the sub-fields SF1, . . . , and SF8 is divided into reset periods R1, . . . , and R8, address periods A1, . . . , and A8, and discharge-sustaining periods S1, . . . , and S8.

The brightness of a PDP is directly proportional to the lengths of the discharge-sustaining periods S1, . . . , and S8 of the unit frame. The lengths of the discharge-sustaining periods S1, . . . , and S8 of the unit frame are 255T (T is a unit time). A time corresponding to 2n is set to a discharge-sustaining period Sn of an n-th sub-field SFn. As such, a sub-field to be displayed is properly selected from the eight sub-fields so that display of 256 level gray-scale including zero gray scale that is not displayed in any sub-field is performed.

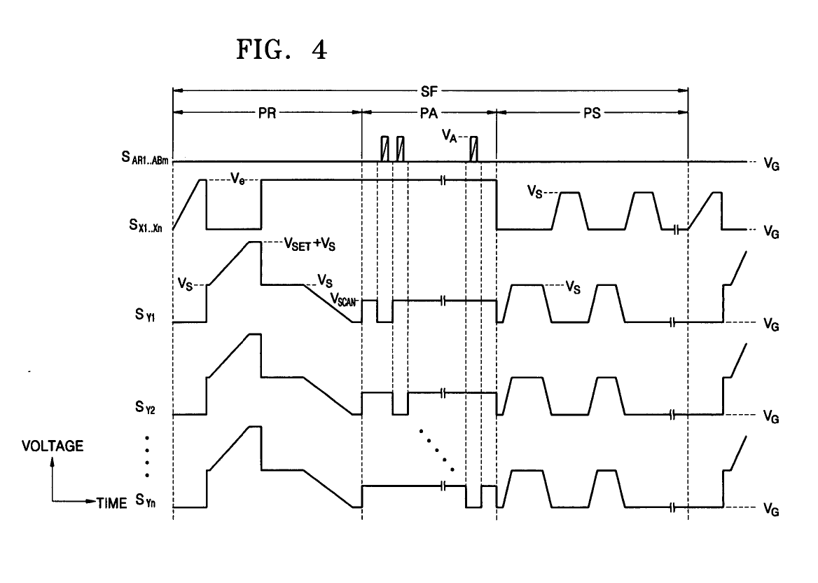

FIG. 4 is a timing diagram of driving signals supplied to electrode lines of the PDP of FIG. 1 at the unit sub-field of FIG. 3. In FIG. 4, reference numeral S_{AR1} . . . A_{Bm} denotes a driving signal supplied to each address electrode line (A_{R1}, A_{G1}, . . . , A_{Gm}, and A_{Bm} of FIG. 1), reference numeral S_{X1} . . . Xₙ denotes a driving signal supplied to X-electrode lines (X₁, . . . , and of FIG. 1), and reference numeral S_{Y1} . . . Yₙ denotes a driving signal supplied to each Y-electrode line (Y₁, . . . , and Yₙ of FIG. 1).

Referring to FIG. 4, in a reset period PR of a unit sub-field SF, first, a voltage supplied to the X-electrode lines X₁, . . . , and Xₙ is increased continuously from a ground voltage V_{G} to a second voltage V_{S}, for example, up to 155V. Here, the ground voltage V_{G} is supplied to the Y-electrode lines Y₁, . . . , and Yₙ and the address electrode lines A_{R1}, A_{G1}, . . . , A_{Gm}, and A_{Bm}.

A voltage supplied to the Y-electrode lines Y₁, . . . , and Yₙ is increased continuously from a second voltage V_{S}, for example, 155V, to a maximum voltage V_{SET}+V_{S} higher than the second voltage V_{S} by a third voltage V_{SET}, for example, up to 355 V. The ground voltage V_{G} is supplied to the X-electrode lines X₁, . . . , and Xⁿ and the address electrode lines A_{R1}, A_{G1}, . . . , A_{Gm}, and A_{Bm}.

While the voltage supplied to the X-electrode lines X₁, . . . , and Xₙ is maintained at the second voltage V_{S}, the voltage supplied to the Y-electrode lines Y₁, . . . , and Yₙ is decreased continuously from the second voltage V_{S} to the ground voltage V_{G}. The ground voltage V_{G} is supplied to the address electrode lines A_{R1}, A_{G1}, . . . , A_{Gm}, and A_{Bm}.

As such, in a in a subsequent address period PA, a display data signal is supplied to address electrode lines, and a scan pulse of the ground voltage V_{G} is sequentially supplied to the Y-electrode lines Y₁, . . . , and Yₙ, which is biased to a fourth voltage V_{SCAN} lower than the second voltage V_{S} such that addressing is smoothly performed. When a discharge cell is to be selected, the display data signal supplied to each of the address electrode lines A_{R1}, A_{G1}, . . . , A_{Gm}, and A_{Bm} has a positive-polarity address voltage V_{A}, and when the discharge cell is not to be selected, the display data signal has the ground voltage V_{G}. As such, when the display data signal having the positive-polarity address voltage V_{A} is supplied to selected address electrode lines, and A_{Bm} while the scan pulse of the ground voltage V_{G} is supplied to the Y-electrode lines Y₁, . . . , and Yₙ, wall charges are formed in corresponding discharge cells by an address discharge, and the wall charges are not formed in non-corresponding discharge cells. In order to perform an address discharge more precisely and effectively, the second voltage V_{S} is supplied to the X-electrode lines X₁, . . . , and Xₙ.

In a subsequent discharge-sustaining period PS, display-sustaining pulses of the second voltage VS are alternately supplied to all of the Y-electrode lines Y₁, . . . , and Yₙ and the X-electrode lines X₁, . . . , and Xₙ such discharge for display-sustaining occurs in display cells in which the wall charges are formed in a corresponding address period PA.

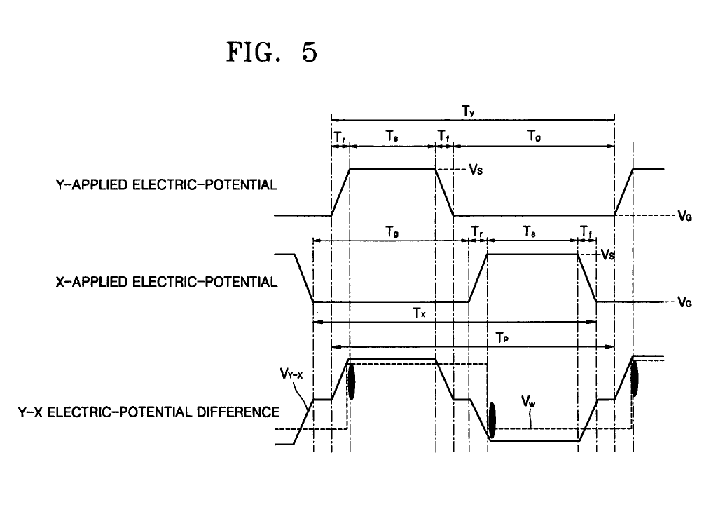

FIG. 5 is a timing diagram of X-supplied electrical-potential, Y-supplied electrical-potential, and a Y-X electrical-potential difference of a discharge-sustaining period of the driving signals of FIG. 4. Referring to FIG. 5, in a discharge-sustaining period, a predetermined number of sustaining pulses of a discharge-sustaining voltage VS are alternately supplied to each of the X-electrode lines X₁, . . . , and Xₙ and the Y-electrode lines Y₁, . . . , and Yₙ based on the reference electrical-potential V_{G} at each sub-field. Each of the sustaining pulses is composed of a rising time Tᵣ, a sustaining time Tₛ, a falling time T_{f}, and an intermittent time T_{g} according to time. The rising time Tᵣ and the falling time T_{f} are respectively rising and falling times taken for charging and recovering an energy, the sustaining-time Tₛ, is a time taken for sustaining the discharge-sustaining voltage V_{S}, and the intermittent time T_{g} is a time taken for sustaining the reference electrical-potential V_{G}.

The time of one sustaining pulse is approximately 4-5 μs, and the rising time Tᵣ and the falling time T_{f} are both approximately 0.3-0.5 μs. As shown in FIG. 5, sustaining pulses are alternately and continuously supplied to each of the X-electrode lines X₁, . . . , and Xₙ and the Y-electrode lines Y₁, . . . , and Yₙ so that the sustaining pulses do not overlap with one another and the sustaining time Tₛ, of an X-supplied electrical-potential period Tₓ, and the sustaining time Ts of a Y-supplied electrical-potential period T_{y} do not overlap with one another.

Due to the sum of a difference V_{Y-X} in electrical-potential supplied to each of the X-electrode lines X₁, . . . , and Xₙ and the Y-electrode lines Y₁, . . . , and Yₙ and a wall voltage V_{W}, a sustaining discharge occurs in a discharge-sustaining period. In other words, when the sum of the Y-X electrical-potential V_{Y-X} and the wall voltage V_{W} is greater than a discharge start voltage, a discharge begins.

However, when the intermittent time T_{g} of the X-supplied electrical-potential period Tₓ and the intermittent time T_{g} of the Y-supplied electrical-potential period T_{y} do not overlap with one another, the time of the display-sustaining period during which a predetermined number of sustaining pulses are supplied to each of the X-electrode lines X₁, . . . , and Xₙ and the Y-electrode lines Y₁, . . . , and Yₙ is long, which results in the restriction of high-speed driving. In other words, in this method of driving a PDP, when the discharge-sustaining period is 4-5 μs, a discharge-sustaining frequency of 200-250 kHz is obtained. In addition, since an energy recovery circuit is used in increasing the energy efficiency of a driving circuit, a discharge-sustaining period of approximately 0.3-0.5 μs is needed in each of the rising time Tᵣ and the falling time T_{f}. Therefore, it is difficult to perform sustaining driving with a frequency of over 300 kHz.

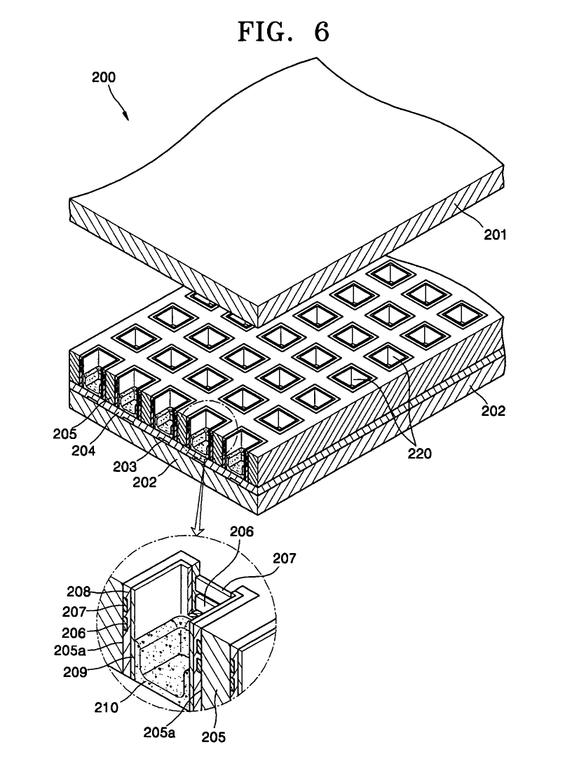

FIG. 6 is a perspective view of a ring plasma discharge PDP according to an embodiment of the present invention in which a method of driving a PDP according to the present invention is performed.

Referring to FIG. 6, a plasma display panel 200 includes a pair of opposite substrates separated from each other by a predetermined gap, for example, a front substrate 201 and a rear substrate 202.

Sidewalls forming a plurality of discharge spaces 220, for example, partition walls 205 are disposed between the front substrate 201 and the rear substrate 202 in a predetermined pattern. The partition walls 205 can have a variety of patterns, for example, closed-Type partition walls such as waffle, matrix, or delta as well as open-type partition walls such as stripes, as long as the partition walls 205 form the plurality of discharge spaces 220. In addition, cross-sections of the discharge spaces 220 of the closed-type partition walls 205 can have circular shapes or elliptical shapes or polygonal shapes such as triangular or pentagonal shapes as well as rectangular shapes.

These sidewalls 205 are components forming a plurality of discharge spaces and are also bases on which discharge electrodes 206 and 207 that will be described later are installed. Thus, the partition walls 205 can be formed in a shape in which the discharge electrodes 206 and 207 are installed so that a discharge begins and is dispersed. For example, side surfaces 205a of the partition walls 205 can extend in a direction perpendicular to the front substrate 201 or in a direction slanted on one side with respect to the direction perpendicular to the front substrate 201. In addition, a portion of the side surfaces 205a can extend in a direction slanted on one side, and the remaining portion thereof can be a curved surface extending in a direction slanted on an opposite side.

By forming the partition walls 205 having a variety of patterns in this manner, the discharge electrodes 206 and 207 can be disposed on the side surfaces 205a of the partition walls 205 in a variety of shapes and patterns such that a discharge begins and is dispersed in various ways in accordance with a variety of discharge surfaces formed by the discharge electrodes 206 and 207. An address electrode 203 is formed on the rear substrate 202 in a predetermined pattern, for example, in the form of stripes. The pattern of the address electrode 203 is not limited to stripes but can have a variety of shapes depending on the shape of the discharge space 220.

The address electrode 203 can be disposed on the rear substrate 202 as in the present embodiment but the present invention is not limited thereto. The address electrode 203 can be disposed in other appropriate places, for example, on the front substrate 201 or on the partition walls 205. In addition, according to the present invention, the address electrode 203 can be eliminated, because a voltage at which the discharge space 220 in which a discharge is to begin is selected can be supplied between the two discharge electrodes 206 and 207 by properly disposing the two discharge electrodes 206 and 207, for example, by disposing the two discharge electrodes 206 and 207 to cross each other, even though the address electrode 220 does not exist.

A rear dielectric layer 204 is formed on the rear substrate 202 to cover the address electrode 220. In the present embodiment, the rear dielectric layer 204 is shown as an element. However, according to the present invention, the rear dielectric layer 204 can be eliminated. In addition, in the present embodiment, the partition walls 205 are installed on the rear dielectric layer 204 but the present invention is not limited thereto. The partition walls 205 can be installed on the rear substrate 202, and the address electrode 220 and the rear dielectric layer 204 can be sequentially disposed on the rear substrate 202 between the partition walls 205.

As shown in FIG. 6, electrodes causing a discharge in the discharge space 220, for example, the X-electrode 207 and the Y-electrode 206 are formed on the partition walls 205. In the present embodiment, the X-electrode 207 and the Y-electrode 206 are formed on the partition walls 205. According to the present invention, the X-electrode 207 and the Y-electrode 206 can be disposed in a variety of shapes and positions as long as a surface discharge occurs on a side surface forming the discharge space 220. For example, as shown in is FIG. 6, each of the X-electrode 207 and the Y-electrode 206 can be formed around the partition walls 205 in the form of a ring on the side surfaces 205a of the partition walls 205.

A distance between the X-electrode 207 and the Y-electrode 206 is formed in such a manner that a surface discharge begins and is dispersed. However, a distance between the X-electrode 207 and the Y-electrode 206 should preferably be as short as possible so that low-voltage driving can be performed. In the present embodiment, the X-electrode 207 and the Y-electrode 206 are formed as a ring but the present invention is not limited thereto and can have a variety of shapes.

For example, in order to dispose an X-electrode 207 and Y-electrodes 206 so that a discharge surface on which a discharge occurs is as wide as possible, the Y-electrodes 206 having a ring shape can be disposed on and under the X-electrode 207 having a ring shape, the X-electrode 207 being interposed between the Y-electrodes 206. Alternatively, the Y-electrodes 206 can be disposed in a reverse manner. By disposing the X-electrode 207 and the Y-electrodes 206 in this way, a surface on which a discharge occurs extends in a lengthwise direction of a discharge space 220. In order to reduce an address voltage supplied between an address electrode 203 and the Y-electrode 206, the Y-electrode 206 can be disposed adjacent to the address electrode 203, that is, adjacent to a rear substrate 202.

In addition, the X-electrode 207 and the Y-electrode 206 can be installed in such a manner that opposite portions thereof are disposed in a direction perpendicular to a substrate, for example, to the front substrate 201 on a side surface of the discharge space 220. In other words, the X-electrode 207 is disposed on the side surface of the discharge space 220 in a lengthwise direction and the Y-electrodes 206 are disposed on both sides of the X-electrode 207 by a predetermined gap to be adjacent to the X-electrode 207 so that opposite portions of the X-electrode 207 and the Y-electrode 206 are perpendicular to the front substrate 201. Each of the discharge electrodes 206 and 207 is disposed to be symmetrical with each other over two adjacent side surfaces of the discharge space 220.

Owing to the discharge electrodes 206 and 207 having the above-described structure, the discharge extends in a circumferential direction of the discharge space 220. In addition, the discharge electrodes 206 and 207 can be formed in a variety of shapes and positions. The X-electrode 207 and the Y-electrode 206 can be formed by a variety of methods, for example, printing, sand blasting, or deposition. Both the X-electrode 207 and the Y-electrode 206 can be disposed on the partition walls 205.

The X-electrode 207 and the Y-electrode 206 can be insulated from each other, for example, by a side surface dielectric layer 208 placed between the X-electrode 207 and the Y-electrode 206. In addition, the side surface dielectric layer 208 can be formed on the partition walls 205 to cover the X-electrode 207 and the Y-electrode 206. Similarly, the Y-electrodes 206 disposed in each of the discharge spaces 220 can be connected to each other.

A layer of MgO can be formed on the side surface dielectric layer 208 to protect the side surface dielectric layer 208. Phosphor 210, which is excited by ultraviolet rays generated by a discharge gas to emit visible light, is arranged in the discharge space 220 formed by the side surface dielectric layer 208, the rear dielectric layer 204, and the front substrate 201. The phosphor 210 can be formed in any position of the discharge space 220. However, taking transmissivity of visible light into account, the phosphor 210 can be disposed at a lower portion of the discharge space 220 which is toward the rear substrate 202, to cover a bottom surface of the discharge space 220 and a lower portion of a side surface.

A discharge gas, such as Ne, Xe, and a mixture thereof, is sealed in the discharge space 220. According to the present invention, a discharge area is enlarged, and the amount of plasma is increased such that low voltage driving is performed. Thus, even though a high-concentration Xe gas is used as a discharge gas, low-voltage driving can be performed such that an emission efficiency is remarkably increased. Owing to this advantage, a problem that it becomes very difficult to perform low-voltage driving when the high-concentration Xe gas is used as the discharge gas in a conventional plasma display panel can be solved.

An upper opening portion of the discharge space 220 is sealed by the front substrate 201. Thus, a discharge electrode or a bus electrode of Indium Tin Oxide (ITO) and a dielectric layer formed on the front substrate to cover the discharge electrode or the bus electrode, which exist in a front substrate of the conventional PDP, do not exist in the front substrate 201. As such, the numerical aperture of the front substrate 201 is remarkably improved, the transmissivity of visible light is remarkably improved as much as 90% such that low-voltage driving is performed to maximize an emission efficiency. The front substrate 201 can be formed of a transparent material, for example, glass.

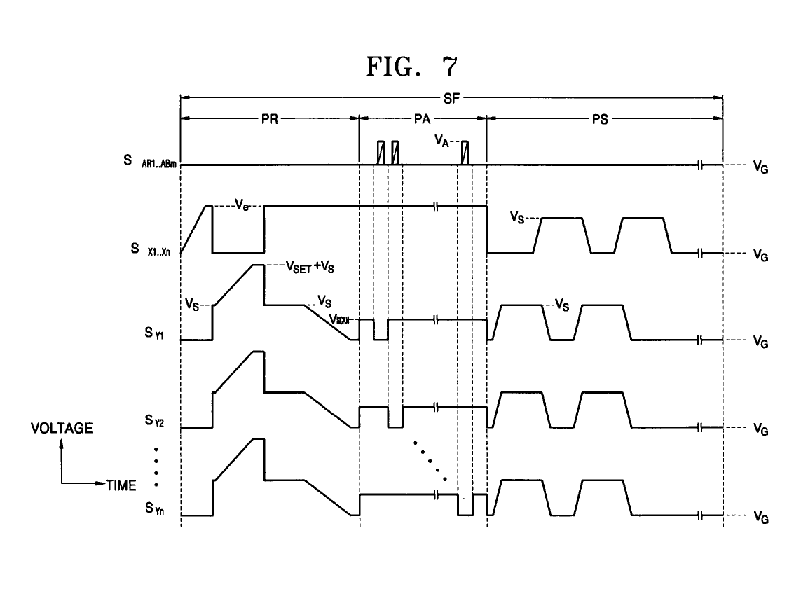

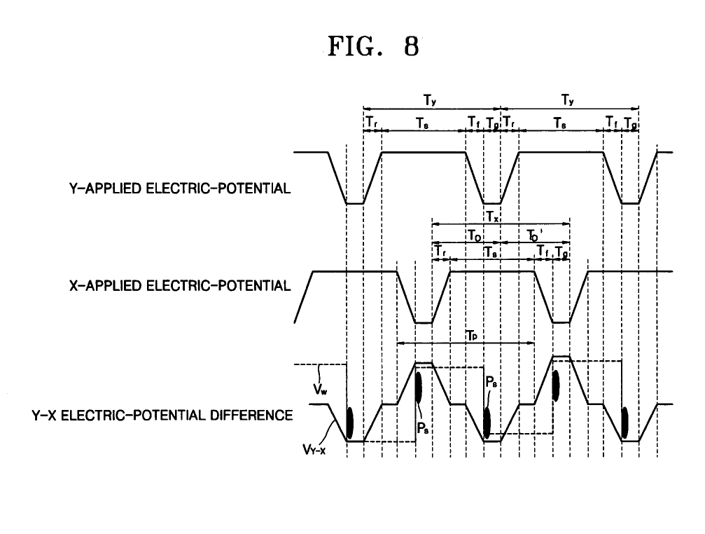

FIG. 7 is a timing diagram of a method of driving a PDP according to an embodiment of the present invention. FIG. 8 is a timing diagram of X-supplied electrical-potential, Y-supplied electrical-potential, and a Y-X electrical-potential difference of a discharge-sustaining period of driving signals of FIG. 7. Referring to FIGS. 7 and 8, in the method of driving a PDP, discharge cells are formed in an area in which address electrode lines (A_{R1}, . . . A_{G1}, A_{Gm}, and A_{Bm} of FIG. 1) overlap with one another with respect to sustaining-electrode line pairs in which X-electrode lines (X₁, . . . , and Xₙ of FIG. 1) and Y-electrode lines (Y₁, . . . , and Yₙ of FIG. 1) between a pair of opposite substrates are alternately arranged in a direction perpendicular to the substrate. A plurality of sub-fields SFs for time division gray-scale display exist in each frame which is a display period, and each of the sub-fields SFs includes a reset period PR, an address period PA, and a discharge-sustaining period PS.

The present embodiment describes the case where an Address-Display Separation (ADS) method shown in FIGS. 3 and 4 is used. However, a method of driving a plasma display panel by which an intermittent time T_{g} of a Y-supplied electrical-potential period T_{y} and an intermittent time T_{g} of a X-supplied electrical-potential period Tₓ in the discharge-sustaining period PS do not overlap with each other temporally, can be applied to other driving methods such as an Address While Display (AWD) method or an address-display mixing driving method or the like.

In the discharge-sustaining period PS, a sustaining pulse of a second level voltage VS based on a first level voltage V_{G} is supplied to each of the Y-electrode lines Y₁, . . . , and Yₙ and the X-electrode lines X₁, . . . , and Xₙ according to the Y-supplied electrical-potential period T_{y} and the X-supplied electrical-potential period Tₓ. Each of the Y-supplied electrical-potential period T_{y} and the X-supplied electrical-potential period Tₓ, includes a rising time Tᵣ to rise from the first level voltage V_{G} to the second level voltage V_{S}, a sustaining time Tₛ to sustain the second level voltage V_{S}, a falling time T_{f} to fall from the second level voltage V_{S} to the first level voltage V_{G}, and an intermittent time T_{g} to sustain the first level voltage V_{G}.

An intermittent time T_{g} of the Y-supplied electrical-potential period T_{y} and an intermittent time T_{g} of the X-supplied electrical-potential period Tₓ do not overlap with each other in time. In other words, a waveform supplied to each of the Y-electrode lines Y₁, . . . , and Yₙ and the X-electrode lines X₁, . . . , and Xₙ is a waveform including a section in which portions of the sustaining time Tₛ, within the Y-supplied electrical-potential period T_{y} and the X-supplied electrical-potential period Tₓ overlap each other.

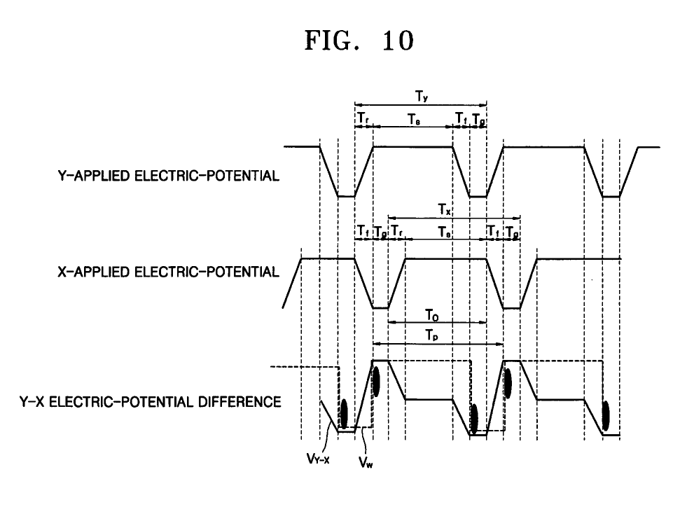

Thus, a waveform supplied to each of the Y-electrode lines Y₁, . . . , and Yₙ and the X-electrode lines X₁, . . . , and Xₙ is a high frequency overlapped-time sustaining waveform in which a period Tₚ of each sustaining pulse becomes shorter and the frequency of each sustaining pulse increases accordingly. Owing to the waveform, a time between discharge-sustaining periods becomes shorter and a discharge frequency increases, such that space charges are utilized during discharge-sustaining periods and emission efficiency is increased, as shown in FIG. 11.

In addition, the sustaining-driving method according to the present embodiment, a sustaining-discharge time is reduced compared to a conventional driving method such that more time is allocated to the reset period PR or the address period PA. In other words, the degrees of freedom of a driving time increases such that the sustaining-driving method is supplied to a single scan method of High Definition (HD) by which an address time is insufficient using the conventional driving method.

Each of the Y-supplied electrical-potential period T_{y} and the X-supplied electrical-potential period Tₓ includes a rising time Tᵣ, a sustaining time Tₛ, a falling time T_{f}, and an intermittent time T_{g}. In the rising time Tᵣ, an supplied voltage increases from the first level voltage V_{G} to the second level voltage V_{S}. In the sustaining time Tₛ, an supplied voltage is maintained at the second level V_{S}. In the falling time T_{f}, an supplied voltage falls from the second level V_{S} to the first level V_{G}. At the intermittent time T_{g}, an supplied voltage is maintained at the first level V_{G}. In this case, the first level V_{G} is the level of a ground voltage, and the second level V_{S} can be 155V, for example, as with the conventional sustaining-driving method.

In this case, an overlapped time Tₒ in which the Y-supplied electrical-potential period T_{y} and the X-supplied electrical-potential period Tₓ overlap each other, exists. The overlapped time Tₒ can include a part of the rising time Tᵣ, the falling time T_{f}, and the sustaining time Tₛ. The overlapped time Tₒ can be longer than the rising time Tᵣ or the falling time T_{f}, as shown in FIG. 10.

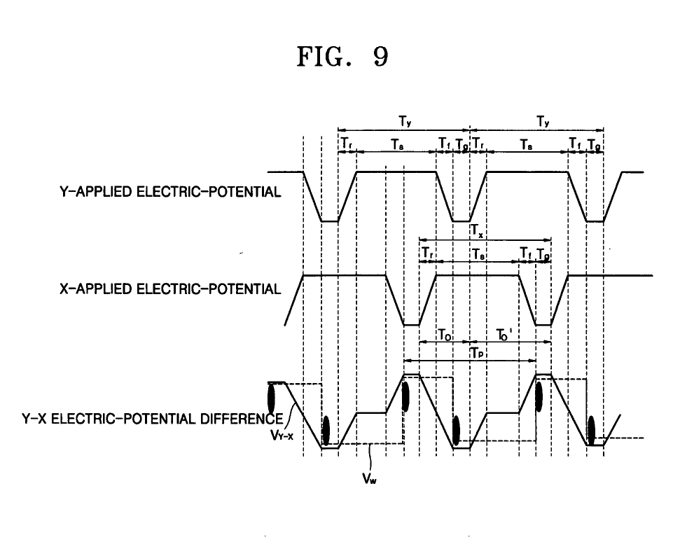

In addition, FIG. 8 shows the case where a part of the sustaining time Tₛ is included in the overlapped time Tₒ. However, as shown in FIGS. 9 and 10, the sustaining time Tₛ can be omitted from the overlapped time Tₒ. As shown in FIG. 10, at least one of the rising time Tᵣ of the Y-supplied electrical-potential period T_{y} and the falling time Tᵣ of the X-supplied electrical-potential period Tₓ can be respectively supplied together with at least one of the falling time T_{f} of the Y-supplied electrical-potential period T_{y} and the rising time Tᵣ of the X-supplied electrical-potential period Tₓ simultaneously.

The sustaining time Tₛ can be longer than the intermittent time T_{g} so that an intermittent time T_{g} of the Y-supplied electrical-potential period T_{y} and an intermittent time T_{g} of the X-supplied electrical-potential period Tₓ do not overlap each other and a part of the rising time Tᵣ, the falling time T_{f}, and the sustaining time Tₛ is included in the overlapped time Tₒ.

As with the conventional driving method, the Y-supplied electrical-potential period T_{y} and the X-supplied electrical-potential period Tₓ can have the same period. In addition, each of the rising time Tᵣ, the sustaining time Tₛ, the falling time T_{f}, and the sustaining time T_{g} in the Y-supplied electrical-potential period T_{y} can be supplied during the same time interval as each of the rising time Tᵣ, the sustaining time Tₛ, the falling time T_{f}, and the intermittent time T_{g} in the X-supplied electrical-potential period Tₓ.

Each of the Y-supplied electrical-potential period T_{y} and the X-supplied electrical-potential period Tₓ can be less than 3 μs. In each Y-supplied electrical-potential period T_{y} and X-supplied electrical-potential period Tₓ, the sustaining time Tₛ is longer than the intermittent time T_{g} and the supplied waveforms thereof overlap each other. Thus, each Y-supplied electrical-potential period T_{y} and X-supplied electrical-potential period Tₓ can be reduced more than in the conventional driving method. In particular, the intermittent time T_{g} can be reduced more. This results in reducing the Y-supplied electrical-potential period T_{y} and the X-supplied electrical-potential period Tₓ so that the frequency of a discharge-sustaining pulse is increased to be greater than 333 kHz.

As shown in FIG. 11, when the frequency of the discharge-sustaining pulse ranges between 200 and 500 kHz, an emission efficiency increases linearly. Thus, the Y-supplied electrical-potential period T_{y} and the X-supplied electrical-potential period Tₓ can be greater than 2 μs, that is, the frequency of the discharge-sustaining pulse can be less than 500 kHz.

A sustaining discharge occurs due the sum of a difference V_{Y-X} in electrical-potential supplied to each of the X-electrode lines X₁, . . . , and Xₙ and a wall voltage V_{W}. In other words, when the sum of the Y-X electrical-potential V_{Y-X} and the wall voltage V_{W} is greater than a discharge start voltage, a discharge begins.

Thus, in the present embodiment, a sustaining discharge occurs when the sustaining time Tₛ and the intermittent time T_{g} of the Y-supplied electrical-potential period T_{y} and the X-supplied electrical-potential period Tₓ overlap each other. The potential difference can be composed of a rising section from a negative electrical-potential level to a ground level, a ground level sustaining section, a rising section from the ground level to a positive electrical-potential level, a positive electrical-potential level sustaining section, a falling section from the positive electrical-potential level to the ground level, the ground level sustaining section, a falling section from the ground level to the negative electrical-potential level, and a negative electrical-potential sustaining section. In the embodiment, the existence of a gradient and the ground level sustaining section can be changed depending on the degree in which each of the Y-supplied electrical-potential period T_{y} and the X-supplied electrical-potential period Tₓ overlap each other.

A positive electrical-potential sustaining discharge occurs in an end portion of the rising section from the ground level to the positive electrical-potential level, and a negative electrical-potential sustaining discharge occurs in an end portion of the falling section from the ground level to the negative electrical-potential level.

FIGS. 9 and 10 are views of methods of driving a PDP according to other embodiments of the present invention, which are timing diagrams illustrating X-supplied electrical-potential, Y-supplied electrical-potential, and a Y-X electrical-potential difference of a discharge-sustaining period of driving signals of FIG. 7. Referring to FIGS. 9 and 10, in the method of driving a PDP, discharge cells are formed in an area in which address electrode lines (A_{R1}, . . . A_{G1}, A_{Gm}, and A_{Bm} of FIG. 1) overlap one another with respect to sustaining-electrode line pairs in which X-electrode lines (X₁, . . . , and Xₙ of FIG. 1) and Y-electrode lines (Y₁, . . . , and Yₙ of FIG. 1) between a pair of opposite substrates are alternately arranged in a direction perpendicular to the substrates. In the method, a plurality of sub-fields SFs for time division gray-scale display exist in each frame which is a display period, and each of the sub-fields SFs includes a reset period PR, an address period PA, and a discharge-sustaining period PS.

In the discharge-sustaining period PS, a sustaining pulse of a second level voltage VS based on a first level voltage V_{G} is supplied to each of the Y-electrode lines Y₁, . . . , and Yₙ and the X-electrode lines X₁, . . . , and Xₙ according to the Y-supplied electrical-potential period T_{y} and the X-supplied electrical-potential period Tₓ. Each Y-supplied electrical-potential period T_{y} and X-supplied electrical-potential period Tₓ, includes a rising time Tᵣ, a sustaining time Tₛ, a falling time T_{f}, and an intermittent time T_{g}.

In the rising time Tᵣ, a supplied voltage increases from the first level voltage V_{G} to the second level voltage V_{S}. In the sustaining time Tₛ, a supplied voltage is maintained at the second level V_{S}. In the falling time T_{f}, a supplied voltage falls from the second level V_{S} to the first level V_{G}. In the intermittent time T_{g}, a supplied voltage is maintained at the first level V_{G}.

An intermittent time T_{g} of the Y-supplied electrical-potential period T_{y} and an intermittent time T_{g} of the X-supplied electrical-potential period Tₓ, do not overlap each other in time.

The embodiments shown in FIGS. 9 and 10 are similar to the embodiment shown in FIG. 8. In the embodiment of FIG. 9, the falling time T_{f} of the Y-supplied electrical-potential period T_{y} following the rising time Tᵣ of the X-supplied electrical-potential period Tₓ is arranged so that a ground level sustaining section can be omitted from the Y-X electrical-potential difference V_{Y-X}, unlike in FIG. 8.

In the embodiment shown in FIG. 10, the rising time Tᵣ of the Y-supplied electrical-potential period T_{y} and the falling time T_{f} of the X-supplied electrical-potential period Tₓ is supplied simultaneously so that the gradient of the Y-X electrical-potential difference V_{Y-X} increases and a section in which the Y-X electrical-potential difference V_{Y-X} increases rapidly exists.

However, in a high frequency overlapped-time sustaining method according to the present invention, if the Y-supplied electrical-potential period T_{y} is the same as the X-supplied electrical-potential period Tₓ in each case, the sustaining pulse discharge period Tₚ from a positive electrical-potential sustaining discharge to a next positive electrical-potential sustaining discharge is the same, and only a distance from a positive electrical-potential sustaining discharge to a negative electrical-potential sustaining discharge and a distance from a negative electrical-potential sustaining discharge to a positive electrical-potential sustaining discharge are changed.

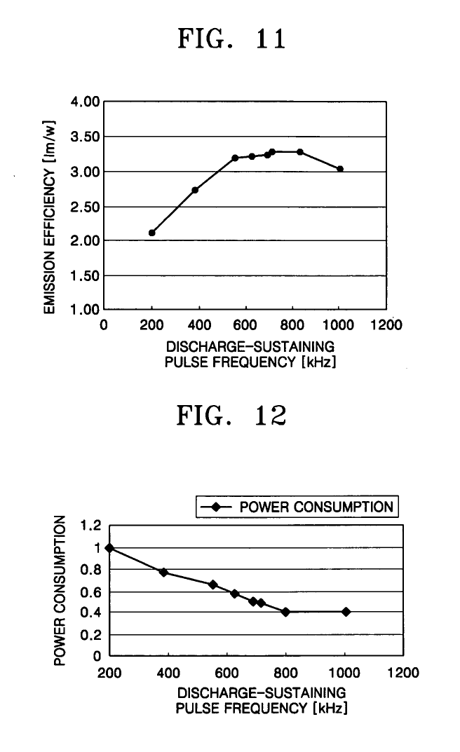

FIG. 11 is a graph of an emission efficiency with respect to a discharge-sustaining pulse frequency in the method of driving a PDP of FIGS. 7 through 10. FIG. 12 is a graph illustrating power consumption with respect to discharge-sustaining pulse frequency in the method of driving a PDP of FIGS. 7 through 10.

Referring to FIG. 11, in the method of driving a PDP according to the present invention, a waveform supplied to each of the Y-electrode lines Y₁, . . . , and Yₙ and the X-electrode lines X₁, . . . , and Xₙ is a high frequency overlapped-time sustaining waveform in which a period Tₚ of each sustaining pulse becomes short and the frequency of each sustaining pulse increases accordingly. Owing to the waveform, a time between discharge-sustaining periods becomes short and a discharge frequency increases, such that space charges are utilized during discharge-sustaining and an emission efficiency is increased, as shown in FIG. 11. However, the emission efficiency only increases linearly at a higher ratio in an area in which the frequency of the discharge-sustaining pulses is 200 kHz to approximately 500 kHz. Thus, taking the limitation of increasing the frequency of discharge-sustaining pulse and a difficulty in increasing the frequency of discharge-sustaining pulse into account, discharge-sustaining pulses of the Y-supplied electrical-potential period T_{y} and the X-supplied electrical-potential period Tₓ can be supplied so that the frequency of discharge-sustaining pulse is between 200 kHz and 500 kHz.

In addition, as shown in FIG. 12, as emission efficiency is increased, power consumption increases.

As described above, in the method of driving a PDP according to the present invention, sustaining pulses supplied to each of X-electrodes and Y-electrodes overlap with one another during a discharge-sustaining period and an overlapped time is adjusted such that the frequency of discharge-sustaining pulse is greater than 300 kHz without increasing the rising time and falling time to charge and recover energy and a time to sustain a discharge is reduced.

In addition, a a discharge-sustaining time period is reduced within one driving period and a sustaining discharge is performed by sustaining pulses having the same number such that a driving time that can be allocated to a reset period or an address period is lengthened so as to realize an equal brightness.

In addition, an emission efficiency of a plasma display apparatus is increased, and power consumption is reduced.

While the present invention has been particularly shown and described with reference to exemplary embodiments thereof, it will be understood by those of ordinary skill in the art that various modifications in form and details can be made therein without departing from the spirit and scope of the present invention as recited in the following claims.

1. A method of driving a plasma display panel, the method comprising:
arranging discharge cells in an area in which address electrode lines overlap with one another with respect to sustaining-electrode line pairs in which X-electrode lines and Y-electrode lines between a pair of opposite substrates are alternately arranged in a direction perpendicular to the substrates; and
providing a plurality of sub-fields for time division gray-scale display in each frame of a display period, each of the plurality of sub-fields including a reset period, an address period and a discharge-sustaining period;
wherein, in the discharge-sustaining period, a sustaining pulse of a second level voltage based on a first level voltage is respectively supplied to each of the Y-electrode lines and X-electrode lines according to a Y-supplied electrical-potential period and an X-supplied electrical-potential period;
wherein each Y-supplied electrical-potential period and X-supplied electrical-potential period includes a rising time to rise from the first level voltage to the second level voltage, a sustaining time to sustain the second level voltage, a falling time to fall from the second level voltage to the first level voltage; and
wherein an intermittent time to sustain the first level voltage, and an intermittent time of the Y-supplied electrical-potential period and an intermittent time of the X-supplied electrical-potential period do not overlap each other in time.

2. The method of claim 1, wherein the sustaining time is longer than the intermittent time, in both the Y-supplied electrical-potential period and the X-supplied electrical-potential period.

3. The method of claim 1, wherein the Y-supplied electrical-potential period and the X-supplied electrical-potential period have the same period.

4. The method of claim 3, wherein each of the rising time, the sustaining time, the falling time, and the intermittent time in the Y-supplied electrical-potential period is supplied during the same time interval as each of the rising time, the sustaining time, the falling time, and the intermittent time in the X-supplied electrical-potential period.

5. The method of claim 1, wherein at least one of the rising time of the Y-supplied electrical-potential period and the falling time of the X-supplied electrical-potential period is respectively supplied together with at least one of the falling time of the Y-supplied electrical-potential period and the rising time of the X-supplied electrical-potential period simultaneously.

6. A method of driving a plasma display panel, the method comprising:
arranging discharge cells in an area in which address electrode lines overlap with one another with respect to sustaining-electrode line pairs in which X-electrode lines and Y-electrode lines between a pair of opposite substrates are alternately arranged in a direction perpendicular to the substrates; and
providing a plurality of sub-fields for time division gray-scale display in each frame of a display period, each of the plurality of sub-fields including a reset period, an address period and a discharge-sustaining period;
wherein, in the discharge-sustaining period, a sustaining pulse of a second level voltage based on a first level voltage is respectively supplied to each of the Y-electrode lines and X-electrode lines according to a Y-supplied electrical-potential period and an X-supplied electrical-potential period;
wherein each Y-supplied electrical-potential period and X-supplied electrical-potential period includes a rising time to rise from the first level voltage to the second level voltage, a sustaining time to sustain the second level voltage, a falling time to fall from the second level voltage to the first level voltage; and
wherein at least one of portions of the rising time, the falling time, and the sustaining time of each Y-supplied electrical-potential period and X-supplied electrical-potential period overlap each other in time.

7. The method of claim 6, wherein a time in which the Y-supplied electrical-potential period and the X-supplied electrical-potential period overlap each other is longer than both the rising time and the falling time.

8. The method of claim 6, wherein the sustaining time is longer than the intermittent time in each of the Y-supplied and X-supplied electrical-potential periods.

9. The method of claim 6, wherein the Y-supplied electrical-potential period and the X-supplied electrical-potential period have the same period.
